(19) United States
(12) Patent Application Publication
(10) Pub. No.: US 2022/0055039 A1
(43) Pub. Date: Feb. 24, 2022

(54) METHOD AND ARRANGEMENT FOR PROCESS WATER TREATMENT

(71) Applicant: Metso Outotec Finland Oy, Tampere (FI)

(72) Inventor: Kaj Jansson, Tampere (FI)

(73) Assignee: Metso Outotec Finland Oy, Tampere (FI)

(21) Appl. No.: 17/415,339

(22) PCT Filed: Dec. 18, 2018
(86) PCT No.: PCT/FI2018/050943

§ 371 Date: Jun. 17, 2021

(51) Int. Cl. B03B 7/00; B03D 1/02; C02F 9/00; C22B 26/12; C22B 11/00

(52) U.S. Cl. CPC B03B 7/00; B03D 1/02; C02F 9/00; C22B 26/12; B03D 1/1431; B03D 2203/008; B03D 2203/02; B03D 2201/002; C22B 11/04

(57) ABSTRACT

A method of treating process water of a flotation plant is disclosed. The flotation plant comprises a mineral flotation line and a process water circuit for treating underflow and/or overflow of the flotation line. The process water circuit comprises a gravitational solid-liquid separator for dewatering underflow and/or overflow of the mineral flotation line to separate sediment from supernatant comprising at least water and unrecovered fine particles comprising valuable material; and a recover water tank for collecting process water. According to the method, prior to leading supernatant from the gravitational solid-liquid separator into the recover water tank, it is subjected to cleaning flotation, in which at least 90% of the flotation gas bubbles have a size from 0.2 to 250 μm, in a cleaning flotation unit. An arrangement for treating process water of a flotation plant, and its use are also disclosed.

### TECHNICAL FIELD

The current disclosure relates to a method and arrangement for treating process water of a flotation plant, and to a use of the arrangement.

### BACKGROUND

The quality of mineral ores is decreasing as best deposits are increasingly already in use or have been used. Therefore the mined ores may contain significantly less valuable material. In order to run profitable operations, it is necessary to liberate all valuable metals or other valuable materials from the deposits.

When valuable minerals are deposited in smaller pockets within a mother stone, there arises a need to grind ore to finer levels, typically to a mean particle size of less than 300 μm, and in case a regrinding circuit is utilized, even less than 100 μm, in order to release valuable material from the less-valuable or valueless matrix, before treating the particles comprising valuable material in a concentration process, such as flotation in a flotation plant. When the ores are ground into a finer particle size, naturally the amount of fine particles, i.e. particles having a mean particle size of less than 10 μm is increased. Fine particles disrupt the main flotation process for example by consuming excess amount of flotation chemicals. Ordinary dispersed air flotation, pneumatic flotation or column flotation processes are not very efficient in recovering fine, light particles because of the flotation gas bubble size of these flotation processes. E.g. froth flotation employs a bubble size range of 600 to 2500 μm, selected for creating sufficient buoyancy for relatively large and coarse ore particles having a particle size over 100 μm.

Removal of unwanted fine particles takes place by desliming the main ore stream in a classification circuit, the reject fraction of which is typically subjected to a gravitational solid-liquid separation in a slime thickener. However, the fine particle fraction may comprise a significant amount of valuable material which is lost if reject flows or flows of undesired material are simply discarded to tailings. In some cases, the amount of valuable material in the fines fraction may be 10 to 30%, and therefore it would be very important to recover this material as well, to increase the economic feasibility of a beneficiation operation.

Typically, the gangue, tailings or underflows comprising undesired or valueless material removed in a flotation process is sent to a tailings dam where the long resident time, typically 20-40 days, is expected to sediment and separate the solids, as well as decompose residual flotation chemicals from the collected and reusable process water. The collected process water is then recirculated back into the beneficiation process.

Prior to leading the aforementioned fractions into a tailings dam, the material flows may be dewatered in various types of gravitational solid-liquid separators such as thickeners from which overflow or supernatant is recirculated into the main flotation process. From a classification circuit undesired material fraction may be subjected to dewatering in a slime thickener, and the fraction intended for a subsequent flotation stage or stages may be subjected to dewatering and/or conditioning in a flotation thickener. Overflow of water or supernatant from these are also collected, stored in recover water tanks and recirculated back into the flotation process to be used in various applications such as dilution water for grinding or conditioning.

Depending on the type of ore treated in a flotation plant, the overflows of water or supernatant, or the process water from those sources, may comprise a significant amount of valuable material in the form of fine particles. Further, the water may comprise residual flotation chemicals, other fine particles such as silicate-containing particles, colloidal and soluble compounds and microbes and/or compounds promoting microbiological growth. In general, this kind of recirculated process water collected from various points of the flotation plant is less than ideal for recirculating back into the flotation process, but more significantly, it can comprise a significant amount of valuable material in the form of fine particles carried over from the main flotation line operations.

Today, water shortage, ecological demands placed by legislation and public pressure, costs and extensive space requirements of the aforementioned conventional tailings methods for process water treatment increasingly put pressure to recirculate process waters as main processes in flotation become at least partially closed-loop systems in terms of water usage. Alternative methods for treatment of tailings flows that enables least partially closed-loop water systems may be needed.

A conventional tailings treatment method with typical resident time of 20-40 days may result in acceptable water quality, allowing the treated process water to be reused in the main flotation process, and in other process steps. Changing over to other tailings methods such as thickened tailings, paste, dry stacking or hybrids of these, will result in much shorter sedimentation time due to the new thickeners needed in these process steps. The shorter sedimentation times, around 3-8 h, or even shorter in cases where the sedimentation is used as a washing stage to separate coarse particle fraction (solid) from a fine particle fraction (liquid), result in more fines, residual chemicals and other harmful or detrimental substances ending up in the thickener overflow, and later in recycled or recirculated process water. Apart from comprising a significant fraction of fine particles with valuable material, these impurities in the recirculated process waters may affect negatively the main flotation process and final product quality if not properly handled prior to recycling the process water back into the main process. Overall, closed water systems result to problems in flotation process runnability and increases disturbances, which makes controlling the flotation process more challenging.

Increase of fine material in thickener overflow may increase the flotation chemical dosage or decrease recovery and quality of desired valuable material. Fines load may also be increased by the need to further comminute low quality ore material by grinding to a smaller particle size, in order for the ore to be in a form that allows recovery of valuable material. Build-up of fines, as well as impurities such as microbes and organic material affects subsequent dewatering negatively. Fine material, especially of silicate origin, disturb the ability of collector chemicals to function as intended because the silica-containing fines may have opposite surface potentials and may thus attach to mineral surfaces and cause steric effect that prevents collectors from attaching onto the particles, or a steric layer so thick that the collector molecule length is not sufficient to make the ore particles hydrophobic - apparent surface energy remains unmodified and attachment to flotation gas bubbles cannot happen. Further, fines comprising only undesired material are more difficult depress into underflow/tailings. Selectivity of reagents decreases with increasing fines amount. Fines in the form of compounds such as colloidal hydroxides and carbonates present in the flotation circuit may become combined and cause large surface areas that react with flotation chemicals and use them up.

Changing over to other tailings methods such as thickened tailings, paste, dry stacking or hybrids of these, will result in much shorter sedimentation time due to the new thickeners needed in these process steps. This leads to much shorter sedimentation time, 3-8 h, that result in more fines, residual chemicals and other harmful or detrimental substances ending up in the thickener overflow, and later in recycled process water. Chemicals and other compounds build up in a closed water loop, as these substances cannot be efficiently removed by standard dewatering operations. Thus, for example, a thickener overflow will comprise material that is difficult to settle, and residual chemicals that will negatively affect the main flotation process. These need to be removed from the overflow if process water is to be recirculated without causing problems in the main processes due to residual flotation chemicals etc. carried over from the dewatering. Fines may pose a problem especially as this kind of system does not depress fines efficiently due to the relatively short residence time. Also microbiological contaminants may cause problems.

### SUMMARY OF THE INVENTION

The method according to the current disclosure is characterized by what is presented in claim 1.

The arrangement according to the current disclosure is characterized by what is presented in claim 23.

The use of the arrangement according to the current disclosure is characterized by what is presented in claim 33.

A method of treating process water of a flotation plant for the recovery of a valuable material is disclosed. The flotation plant comprises a mineral flotation line comprising a grinding mill; a classification circuit for classifying a feed of ground ore from the grinding mill into classifier overflow and classifier underflow; and a mineral flotation circuit for treating classifier overflow as infeed of ore particles comprising valuable material suspended in slurry, the flotation circuit comprising a rougher part for the separation of slurry infeed into rougher overflow of recovered valuable material and rougher underflow of reject, and a cleaner part arranged to receive rougher overflow from the rougher part as slurry infeed, for the separation of slurry into cleaner overflow of recovered valuable material and cleaner underflow arranged to flow back into the rougher part as slurry infeed. The flotation plant further comprises a process water circuit for treating underflow and/or overflow of the mineral flotation line, the process water circuit comprising a gravitational solid-liquid separator for dewatering underflow and/or overflow of the mineral flotation line to separate sediment from supernatant comprising at least water and unrecovered fine particles comprising valuable material; and a recover water tank for collecting process water comprising overflow and/or underflow from the mineral flotation line. The method is characterized in that, prior to leading supernatant from the gravitational solid-liquid separator into the recover water tank, supernatant is subjected to cleaning flotation, in which at least 90% of the flotation gas bubbles have a size from 0.2 to 250 μm, in a cleaning flotation unit for collecting at least unrecovered fine particles comprising valuable material; for separating fine particles comprising valuable material from the supernatant into cleaning flotation overflow as recovered valuable material; and for forming purified process water as cleaning flotation underflow; and in that purified process water is recirculated into the mineral flotation line, or collected into the recover water tank as collected process water.

In another aspect of the invention, an arrangement for of treating process water of a flotation plant for the recovery of a valuable material is disclosed. The flotation plant comprises a mineral flotation line comprising a grinding mill; a classification circuit for classifying a feed of ground ore from the grinding mill into classifier overflow and classifier underflow; and a mineral flotation circuit for treating ore particles comprising valuable material and suspended in slurry, the flotation circuit comprising a rougher part for the separation of slurry infeed into rougher overflow of recovered valuable material and rougher underflow of reject, and a cleaner part arranged to receive rougher overflow from the rougher part as slurry infeed, for the separation of slurry into cleaner overflow of recovered valuable material and cleaner underflow arranged to flow back into the rougher part as slurry infeed. The flotation plant further comprises a process water circuit for treating underflow and/or overflow of the mineral flotation line, the process water treatment circuit comprising a gravitational solid-liquid separator arranged to dewater underflow and/or overflow of the mineral flotation line to separate sediment from supernatant comprising at least water and unrecovered fine particles comprising valuable material; and a recover water tank for collecting process water comprising overflow and/or underflow from the mineral flotation line. The arrangement is characterized in that the water treatment circuit further comprises a cleaning flotation unit employing flotation gas bubbles of which at least 90% have a size from 0.2 to 250 μm, operationally connected to the gravitational solid-liquid separator for receiving supernatant prior to it being led into the recover water tank, and arranged to collect at least unrecovered fine particles comprising valuable material; to separate fine particles comprising valuable material from the supernatant into cleaning flotation overflow as recovered valuable material; and to form purified process water as cleaning flotation underflow configured to be recirculated into the mineral flotation line, or collected into the recover water tank as collected process water.

In yet another aspect of the invention, use of the arrangement for of treating process water of a flotation plant for the recovery of a valuable material is disclosed, wherein the arrangement is used for recovering valuable material from ore having a density under 4 g/cm³, preferably 2.4 to 3.2 g/cm³.

With the invention the aforementioned problems in water recirculation and downsides associated with conventional solutions may be alleviated. Overflow or supernatant from a gravitational solid-liquid separator is subjected to cleaning flotation in a cleaning flotation unit so that fine particles, especially those comprising valuable material may be 1) floated and collected into overflow of the cleaning flotation—the collector chemicals carried over from the main flotation processes may act as collectors to the fine particles, or else additional chemicals may be utilized to further enhance the collection efficiency, 2) separated from the thus purified process water by the cleaning flotation step, and 3) collected away to be further treated as concentrate, thereby increasing the overall recovery rate of the flotation plant. In some instances, for example a desliming thickener overflow or supernatant may comprise as high as 40% of valuable material, which would be lost if not collected in the cleaning flotation step or unit.

Especially in connection with easily comminuted ores, i.e. ores or minerals with relatively low density, such as spodumene (lithium aluminium inosilicate, LiAl(SiO₃)₂) or PGM minerals, a significant amount of fines are created in a grinding circuit, and further, in a regrinding circuit. Typically, these fines are removed from the ground material bound to flotation in a classifier circuit, especially in cyclones classifying the ground material into accept or overflow destined for the flotation process and reject or underflow of too-fine particles. To remove the fine particles from the classifier underflow, a desliming thickener is used to obtain fines-free process water for further use.

As discussed above, the fine particle fraction may comprise a significant amount of valuable material, for example lithium or platinum. By recovering that fine material fraction, instead of eventually losing the fine particles and the valuable material they comprise into tailings dam or recirculating them back into the main flotation line where they again most likely end up in the underflows, and additionally, may disrupt the flotation process, the overall recovery of valuable material may be increased with the invention.

Additionally, the resulting purified process water can be readily recirculated back into the main flotation process. As the purified process water comprises significantly less residual flotation chemicals and fine particles, it may not affect the main flotation process detrimentally.

As the overflow from the mineral or main flotation process resides relatively short time in the gravitational solid-liquid separator, the flotation chemicals, collectors carried over in overflow from the main flotation process, do not decompose, as would happen in a conventional tailings dam over time. These collector chemicals may then be utilized in the cleaning flotation step as collectors, thereby making the floating and collection of desired material possible, i.e. collection of fine particles, thus resulting in purified process water. At the same time, these residual flotation chemicals become used up, and they do not carry over back into the main mineral flotation process when the purified process water is recirculated back. Thus, the main flotation process is unaffected by such undesired flotation chemicals, making the controlling of the mineral flotation process easier.

In the cleaning flotation process, other colloidal material such as C, P, N present in very fine particles may also be removed, as well as any starch-based depressants present in the process water, thereby removing nutrients that would promote microbiological growth in the purified process water. This may improve the result of any subsequent water treatment stages such as filtering. For example, the removal of such material may prevent blocking of filter orifices of ceramic filters.

As the slurry or gravitational solid-liquid separator overflow comprises only fine particles (larger particles end up in sediment), the cleaning flotation may be energy-efficiently utilized at a stage where it is most efficient, i.e. for removing fine particles.

In an embodiment of the method, the process water circuit comprises a first gravitational solid-liquid separator for dewatering classifier underflow to separate first sediment from supernatant comprising at least water and unrecovered fine particles comprising valuable material; first sediment arranged to flow into the filtering circuit for the recovery of valuable material and supernatant collected into the recover water tank as collected process water.

In a further embodiment, prior to leading supernatant from the first gravitational solid-liquid separator into the recover water tank, supernatant is subjected to cleaning flotation, in which at least 90% of the flotation gas bubbles have a size from 0.2 to 250 μm, in a first cleaning flotation unit for collecting at least unrecovered fine particles comprising valuable material; for separating fine particles comprising valuable material from supernatant into cleaning flotation overflow as recovered valuable material; and for forming purified process water as cleaning flotation underflow; and in that purified process water is recirculated into the mineral flotation line, or collected into the recover water tank as collected process water.

In an embodiment, the process water circuit comprises a second gravitational solid-liquid separator for dewatering classifier overflow to separate second sediment from supernatant comprising at least water and unrecovered fine particles comprising valuable material; second sediment led into the mineral flotation circuit as slurry infeed; and supernatant collected into the recover water tank as collected process water.

In an embodiment, the process water circuit comprises a third gravitational solid-liquid separator for dewatering cleaner overflow from the flotation circuit to separate third sediment from supernatant comprising at least water and unrecovered fine particles comprising valuable material; supernatant collected into the recover water tank as collected process water.

In an embodiment, the process water circuit comprises a fourth gravitational solid-liquid separator for dewatering rougher underflow from the flotation circuit to separate fourth sediment from supernatant comprising at least water and unrecovered fine particles comprising valuable material; supernatant collected into the recover water tank as collected process water.

In an embodiment, prior to recirculating collected process water from the recover water tank into the mineral flotation line, collected process water is subjected to cleaning flotation, in which at least 90% of the flotation gas bubbles have a size from 0.2 to 250 μm, in a second cleaning flotation unit for collecting at least unrecovered fine particles comprising valuable material, for separating fine particles comprising valuable material from collected process water into cleaning flotation overflow as recovered valuable material, and for forming purified process water as cleaning flotation underflow; and in that purified process water is recirculated into the mineral flotation line.

Depending on the configuration of the flotation line, the process water circuit may comprise a number of gravitational solid-liquid separators configured to treat overflows and/or underflows from a number of sources in the flotation line. Supernatant or supernatants from these may then be treated in the cleaning flotation as needed, to recover fine particles comprising valuable material, in order to improve the overall recovery of valuable material of the flotation plant. In one particular embodiment, the underflow from the classification circuit is led, via a gravitational solid-liquid separator into a cleaning flotation step to ensure the recovery of fine particles comprising valuable material from the classification circuit, which often may comprise a significant amount of such fine particles.

In an embodiment, prior to leading overflow and/or underflow from the mineral flotation line to a gravitational solid-liquid separator, the concentration of overflow and/or underflow is adjusted to 0.5 to 15 w-%.

In a further embodiment, turbulent flow of overflow and/or underflow from the mineral flotation line is adjusted to a laminar flow as it is led into the gravitational solid-liquid separator.

In an embodiment, at least 40% of fine particles comprising valuable material, unrecovered in the mineral flotation line, are recovered from supernatant of a gravitational solid-liquid separator.

In an embodiment, the residence time of overflow and/or underflow from the mineral flotation line in the gravitational solid-liquid separator is under 10 hours, preferably 0.5 to 8 hours.

A relatively short residence time means that the flotation chemicals, in particular the collector chemicals are not decomposed but are carried over with supernatant, and they may be utilized in the subsequent cleaning flotation step. Concurrently, the fine particles do not have time to descend into sediment, which would happen in time in the relatively low-turbulence gravitational solid-liquid separators. Adjusting the flow of underflow and/or overflow from the flotation line to display a laminar flow pattern, the separation or washing of fine particles from particles descending to sediment may be improved. By effecting a desired solids content into the sediment, the amount of solid tailings to be treated may be decreased.

In an embodiment, prior to leading supernatant from a gravitational solid-liquid separator into cleaning flotation, supernatant is led into a separator overflow tank.

A separator overflow tank may be used to control the flow of supernatant into the cleaning flotation unit, or into a mixing unit, if such is used. This may help in stabilizing the overall process water treatment operation, as the flow supernatant into the subsequent operational steps is controlled.

In an embodiment, prior to leading supernatant from a gravitational solid-liquid separator into cleaning flotation, supernatant is led into mixing unit for chemically conditioning supernatant by adding a coagulant and/or a flocculant to flocculate at least fine particles comprising valuable material in supernatant.

In a further embodiment, the coagulant is chosen from a group comprising: inorganic collector, aluminium salts, iron salts, organic coagulants.

In yet another embodiment, a coagulant is added into supernatant in an amount of 1 to 2000 ppm.

In an embodiment, the flocculant is chosen from a group comprising: natural polymers, synthetic flocculants.

In a further embodiment, a flocculant is added into supernatant in an amount of 1 to 100 ppm.

While normally there are enough flotation chemicals (collector chemicals) present as carry-over from the main flotation process in the supernatant, in some cases, it may be necessary to condition the supernatant before the cleaning flotation treatment, to ensure that enough of the fine particles comprising valuable material may be removed by the cleaning flotation unit. This may be done in a conventional mixing unit configured to allow addition of different chemicals, such as flocculants and/or coagulants, and treatment of fluid with those chemicals. The amount of coagulant and/or flocculant is chosen based on the process, and is highly directed by cost of the chemicals. Organic coagulants are more expensive than inorganic ones. Typically, flocculants are added in amounts under 10 ppm.

In an embodiment, the temperature of supernatant is adjusted to 2-60° C. prior to leading it into a cleaning flotation unit.

In an embodiment, the pH of supernatant is adjusted to 6-12 prior to leading in into a cleaning flotation unit.

The temperature and/or the pH of the supernatant may be inherent, i.e. caused by the preceding process steps or environment, or, when desired, the properties may be adjusted as needed, for example to optimize the cleaning flotation.

In an embodiment, the cleaning flotation unit is a dissolved gas flotation (DAF) unit.

DAF is a microflotation process which is used in various applications in water or effluent clarification. Solid particles are separated from liquid by using very small flotation gas bubbles, microbubbles. The microbubbles with a size range of 30-100 μm are generated by dissolving air or other flotation gas into the liquid under pressure. The bubbles are formed in a pressure drop when dispersion is released. The particles of solid form attach to the bubbles and rise to the surface. A formed, floating sludge is removed from the liquid surface with sludge rollers as DAF overflow. Chemicals may sometimes be needed to aid flocculation and increase solids removal efficiency. Typically, colloids removal is possible with efficient coagulation.

In an embodiment, the valuable material is Li.

In an embodiment, the valuable material is Pt.

In an embodiment of the arrangement, the process water circuit comprises a first gravitational solid-liquid separator arranged to dewater classifier underflow to separate first sediment from supernatant comprising at least water and unrecovered fine particles comprising valuable material; first sediment arranged to flow into the filtering circuit for the recovery of valuable material, and supernatant configured to be collected into the recover water tank as collected process water.

In a further embodiment, the water treatment circuit comprises a first cleaning flotation unit employing flotation gas bubbles of which at least 90% have a size from 0.2 to 250 μm, operationally connected to the first gravitational solid-liquid separator for receiving supernatant, and arranged to collect at least unrecovered fine particles comprising valuable material; to separate fine particles comprising valuable material from supernatant into cleaning flotation overflow as recovered valuable material; and to form purified process water as cleaning flotation underflow configured to be recirculated into the mineral flotation line, or collected into the recover water tank as collected process water.

In an embodiment, the process water circuit comprises a second gravitational solid-liquid separator arranged to dewater classifier overflow to separate second sediment from supernatant comprising at least water and unrecovered fine particles comprising valuable material; second sediment arranged to flow into the mineral flotation circuit as slurry infeed, and supernatant configured to be collected into the recover water tank as collected process water,

In an embodiment, the process water circuit comprises a third gravitational solid-liquid separator arranged to dewater cleaner overflow from the mineral flotation circuit to separate third sediment from supernatant comprising at least water and unrecovered fine particles comprising valuable material; supernatant configured to be collected into the recover water tank as collected process water.

In an embodiment, the process water circuit comprises a fourth gravitational solid-liquid separator arranged to dewater rougher underflow from the mineral flotation circuit to separate fourth sediment from supernatant comprising at least water and unrecovered fine particles comprising valuable material; supernatant configured to be collected into the recover water tank as collected process water.

In an embodiment, the process water circuit further comprises a second cleaning flotation unit employing flotation gas bubbles of which at least 90% have a size from 0.2 to 250 μm, operationally connected to the recover water tank for receiving collected process water, and arranged to collect at least unrecovered fine particles comprising valuable material, to separate fine particles comprising valuable material from collected process water into cleaning flotation overflow as recovered valuable material, and to form purified process water as cleaning flotation underflow; purified process water is configured to be recirculated into the mineral flotation line.

In an embodiment, the process water circuit comprises a separator overflow tank into which supernatant from a gravitational solid-liquid separator is configured to flow prior to being led into cleaning flotation.

In an embodiment, the process water circuit further comprises a mixing unit into which supernatant from a gravitational solid-liquid separator is configured to flow prior to being led into cleaning flotation, the mixing unit arranged to chemically condition supernatant to flocculate at least fine particles comprising valuable material in supernatant.

In an embodiment, the cleaning flotation unit is a dissolved gas flotation (DAF) unit.

In an embodiment of the use, the arrangement is used for recovering Li.

In an embodiment, the arrangement is used for recovering Li from spodumene.

In an embodiment, the arrangement is used for recovering Pt.

In an embodiment, the arrangement is used for recovering Pt from a PGM mineral.

The aim of the method and arrangement according to the present invention is to remove as much of the fine particles as possible from the mineral flotation line underflow and/or overflow. At the same time, as a side effect, residual flotation chemicals become used up and removed. Thus, the valuable material in the fine particles may be recovered, and overall recovery rate of the flotation line improved. In addition, as fine particles and residual chemicals remaining in the purified process water are detrimental to the main flotation process, and may decrease the quality and value of the end product (valuable metals/minerals), the problems associated with recirculating process waters back into the main flotation process may be alleviated. Both instances also decrease efficiency of the mineral flotation processes. Removal of excess fine particles and residual flotation chemicals may decrease the consumption of fresh flotation chemicals, and fresh water.

### BRIEF DESCRIPTION OF THE DRAWINGS

The accompanying drawings, which are included to provide a further understanding of the current disclosure and which constitute a part of this specification, illustrate embodiments of the disclosure and together with the description help to explain the principles of the current disclosure. In the drawings:

FIGS. 1-3 are a simplified presentations of flotation arrangements in which embodiments of the method according to the invention may be used.

### DETAILED DESCRIPTION

Reference will now be made in detail to the embodiments of the present disclosure, an example of which is illustrated in the accompanying drawings.

The description below discloses some embodiments in such a detail that a person skilled in the art is able to utilize the flotation arrangement and its use, and the method based on the disclosure. Not all steps of the embodiments are discussed in detail, as many of the steps will be obvious for the person skilled in the art based on this disclosure.

For reasons of simplicity, item numbers will be maintained in the following exemplary embodiments in the case of repeating components.

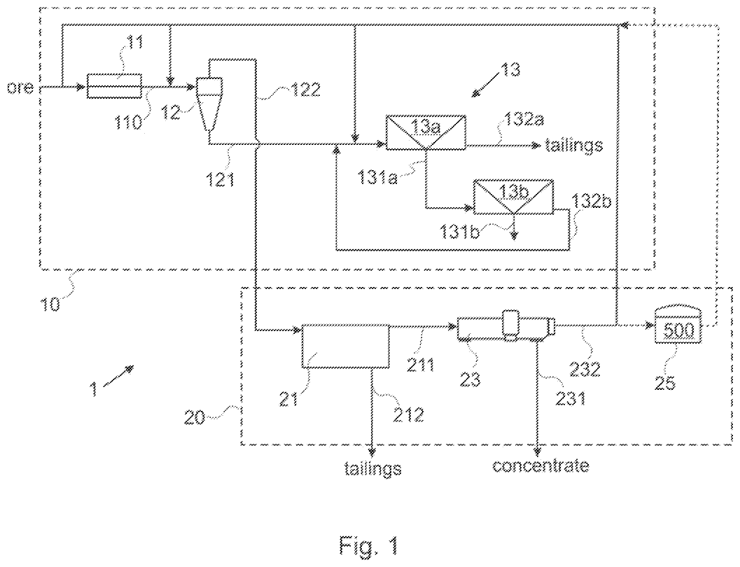

The enclosed FIGS. 1-3 illustrate a flotation plant 1 in a schematic manner. The figures are not drawn to proportion, and many of the components of are omitted for clarity. Some of the components are presented as boxes representing an entire process.

The embodiments described hereinbefore may be used in any combination with each other. Several of the embodiments may be combined together to form a further embodiment. A flotation cell to which the disclosure is related, may comprise at least one of the embodiments described hereinbefore. It is obvious to a person skilled in the art that with the advancement of technology, the basic idea of the invention may be implemented in various ways. The invention and its embodiments are thus not limited to the examples described above; instead they may vary within the scope of the claims.

The flotation plant 1 comprises a mineral flotation line 10. In the mineral flotation line 10 there is a grinding mill 11 in which ore raw material, for example spodumene, is ground to a suitable particle size or a suitable particle size distribution prior to a flotation process, for example to a particle size of less than 300 μm, or less than 100 μm. At the same time, a fraction of fine particles, having a mean particle size of less than 10 μm, is created. In order to produce a slurry comprising particles having a suitable particle size range for flotation, a feed of ground ore is led into a classification circuit 12 comprising a number of classifiers such as cyclones and magnetic separators (not shown in the figures), as is commonly known in the field. For example, a cyclone separates ore particles according to their density, directing coarse particles into accept which may then be further classified in a magnetic separator to separate iron-comprising part of the ore particles, such as magnetite, from the feed of slurry into the flotation circuit. In short, the classification circuit 12 separates the ground ore into classifier overflow 121, to be treated in a mineral flotation circuit 13, and underflow 122 removed from the flotation line 10. The classification circuit 12 may be arranged in any suitable manner in accordance with the ore raw material and flotation process, as is self-evident to a person skilled in the art.

The flotation line 10 further comprises a mineral flotation circuit 13 for treating classifier overflow 121 as infeed of ore particles comprising valuable material suspended in slurry. Prior to leading classifier overflow 121 into the mineral flotation circuit 13, it may be conditioned and/or otherwise pre-treated in any suitable conventional manner, to prepare classifier overflow 121 into an infeed of slurry, for example by adding flotation chemicals.

The mineral flotation circuit 13 comprises a rougher part 13a for the separation of slurry infeed into rougher overflow 131a of recovered valuable material, and rougher underflow 132a of reject. The mineral flotation circuit further comprises a cleaner part 13b arranged to receive rougher overflow 131a from the rougher part 13a as slurry infeed, for the separation of slurry into cleaner overflow 131b of recovered valuable material, and cleaner underflow 132b which is arranged to flow back into the rougher part 13a as slurry infeed, to be treated again in a conventional manner.

The flotation plant 1 further comprises a process water circuit 20 for treating underflow and/or overflow 121, 122, 131b, 132a of the flotation line 10. The process water circuit 20 comprises a gravitational solid-liquid separator 21 for dewatering underflow and/or overflow 121, 122, 131b, 132a of the mineral flotation line 10, to separate sediment 212 from supernatant 211. The supernatant 211 comprises at least water and unrecovered fine particles comprising valuable material. The gravitational solid-liquid separator 21 may be of any suitable type known in the technical field, and selected according to the process requirements of the flotation plant 1 and/or the flotation line 10, as is self-evident for a person skilled in the art. The gravitational solid-liquid separator 21 may, for example be a thickener such as a tailings thickener (conventional thickener, high-rate thickener, high concentration thickener or a paste thickener), or a clarifier.

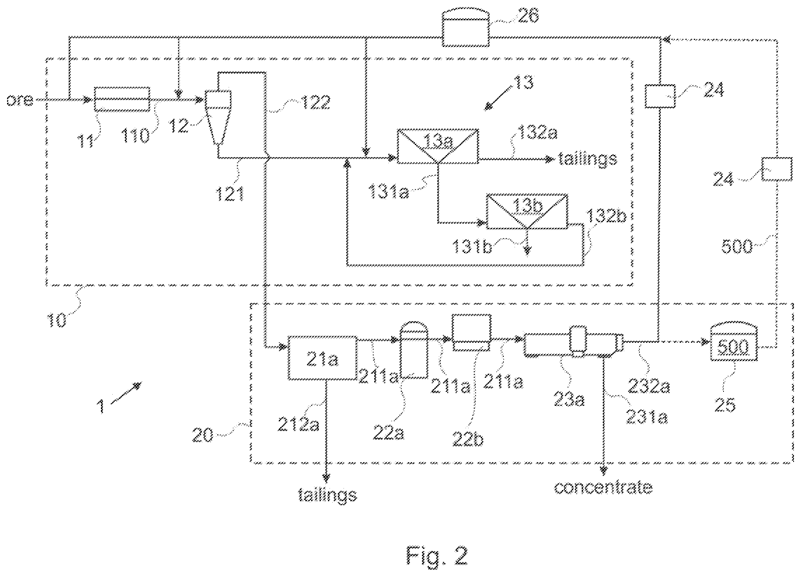

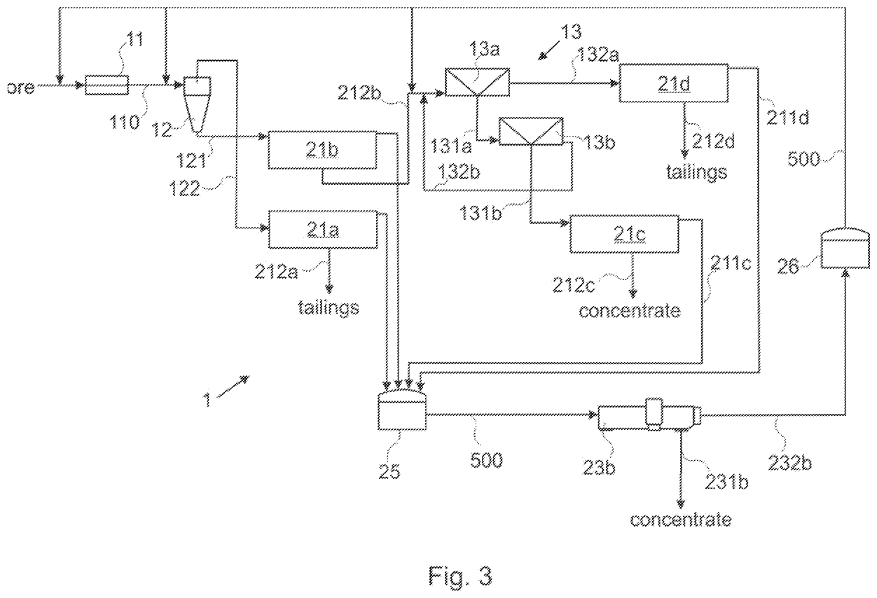

The process water circuit 20 comprises also a recover water tank 25 for collecting process water 500 comprising overflow and/or underflow from the mineral flotation line 10. There may also be another recover water tank 26 for collecting and/or storing purified process water 232, 232a, 232b prior recirculating it back into the flotation line 10 as process water 500 (see FIGS. 2 and 3).

The gravitational solid-liquid separator 21 may be a first gravitational solid-liquid separator 21a arranged to dewater classifier underflow 122 to separate first sediment 212a from supernatant 211a comprising at least water and unrecovered fine particles comprising valuable material. First sediment 212a is arranged to flow into a filtering circuit (not shown in the figures for the recovery of valuable material, as is conventionally done, and supernatant 211a is configured to be collected into the recover water tank as collected process water. First sediment 212a is removed from the flotation plant 1 as tailings, and treated in a conventional manner, for example in a tailings dam (not shown in the figures.

Alternatively or additionally, the gravitational solid-liquid separator 21 may be a second gravitational solid-liquid separator 21b arranged to dewater classifier overflow 121 to separate second sediment 212b from supernatant 211b comprising at least water and unrecovered fine particles comprising valuable material. Second sediment 212b is arranged to flow into the mineral flotation circuit 13 as slurry infeed, and supernatant 211b is configured to be collected into the recover water tank 25 as collected process water 500.

Alternatively or additionally, the gravitational solid-liquid separator 21 may be a third gravitational solid-liquid separator 21c arranged to dewater cleaner overflow 131b from the mineral flotation circuit 13 to separate third sediment 212c from supernatant 211c comprising at least water, unrecovered fine particles comprising valuable material. The supernatant 211c from the third gravitational solid-liquid separator 21c may further comprise residual flotation chemicals and microbes and other soluble or colloidal substances as carry-over from the flotation line 10. Supernatant 211c is configured to be collected into the recover water tank 25 as collected process water 500. Third sediment 212c is recovered as concentrate and treated in a conventional manner to recover the desired valuable material.

Alternatively or additionally, the gravitational solid-liquid separator 21 may be a fourth gravitational solid-liquid separator 21d arranged to dewater rougher underflow 132a from the mineral flotation circuit 13 to separate fourth sediment 212d from supernatant 211d comprising at least water and unrecovered fine particles comprising valuable material. The supernatant 211d may further comprise residual flotation chemicals and microbes, and other soluble or colloidal substances as carry-over form the flotation line 10. Supernatant 211d is configured to be collected into the recover water tank 25 as collected process water 500. Fourth sediment 212d is removed from the flotation plant 1 as tailings.

The process water circuit 20 comprises a cleaning flotation unit 23 employing flotation gas bubbles of which at least 90% have a size from 0.2 to 250 μm, operationally connected to the gravitational solid-liquid separator 21 for receiving supernatant 211 prior to it being led into the recover water tank 25. The cleaning flotation unit 23 is arranged 1) to collect at least unrecovered fine particles comprising valuable material; 2) to separate fine particles comprising valuable material from the supernatant into cleaning flotation overflow 231 as recovered valuable material; and 3) to form purified process water 232 as cleaning flotation underflow configured to be recirculated into the mineral flotation line 10, or collected into the recover water tank 25 as collected process water 500.

The cleaning flotation unit 23 may be a first cleaning flotation unit 23a employing flotation gas bubbles of which at least 90% have a size from 0.2 to 250 μm, operationally connected to the first gravitational solid-liquid separator 21a for receiving supernatant 211a, and arranged 1) to collect at least unrecovered fine particles comprising valuable material; 2) to separate fine particles comprising valuable material from the supernatant into cleaning flotation overflow 231a as recovered valuable material; and 3) to form purified process water 232a as cleaning flotation underflow configured to be recirculated into the mineral flotation line 10, or collected into the recover water tank 25 as collected process water 500.

Alternatively or additionally, the cleaning flotation unit 23 may be a second cleaning flotation unit 23b employing flotation gas bubbles of which at least 90% have a size from 0.2 to 250 μm, operationally connected to the recover water tank 25 for receiving collected process water 500, and arranged 1) to collect at least unrecovered fine particles comprising valuable material, 2) to separate fine particles comprising valuable material from the collected process water into cleaning flotation overflow 231b as recovered valuable material, and 3) to form purified process water 232b as cleaning flotation underflow; purified process water is configured to be recirculated into the mineral flotation line 10.

Depending on the configuration of the flotation plant 1, the process water circuit 20 may thus comprise 1 to 4 gravitational solid-liquid separators 21. Depending on their location within the flotation plant, the gravitational solid-liquid separators 21, 21a, 21b, 21c, 21d may be chosen from a list comprising: a slime thickener, a flotation thickener, a valuable material concentrate thickener, a tailings thickener.

In order to recover fine particles comprising valuable material from overflow and/or underflow of the flotation line 10, supernatant 211a, 211b, 211c, 211d from a gravitational solid-liquid separator or from a number of gravitational solid-liquid separators 21a, 21b, 21c, 21d may first be collected into the recover water tank 25, and the led into the second cleaning flotation unit 23b (FIG. 3).

Alternatively or additionally, supernatant 211a from the first gravitational solid-liquid separator 21a may be first led into the first cleaning flotation unit 23a, and then led into the recover water tank 25, or recirculated back into the flotation line 10 at some suitable point of the flotation line 10, for example as dilution water, i.e. the configuration may be a combination of the alternatives shown in FIGS. 2 and 3.

The cleaning flotation units 23, 23a, 23b employs flotation gas to float particles collected by collector chemicals. In particular, flotation in the cleaning flotation units 23, 23a, 23b is executed by utilizing microbubbles, or flotation gas bubbles having a particular size range. In the cleaning flotation and cleaning flotation units 23, 23a, 23b according to the invention, at least 90% of the flotation gas bubbles fall into a size range of 2 to 250 μm. The cleaning flotation may employ dissolved gas flotation (DAF), and the cleaning flotation units 23, 23a, 23b may be a DAF unit. Other methods for effecting flotation with smaller sized flotation gas bubbles may also be employed, such as electrical double layer flotation or membrane flotation.

Additionally, the process water circuit 20 may comprise a filtering unit 24 to remove microbes and chemicals promoting microbiological growth, or to remove any other undesired chemicals from the purified process water (see FIG. 2). The filtering unit 24 may be of any type known in the field. In an embodiment, the filtering unit 24 comprises a ceramic filter or a number of ceramic filters. The filtering unit may be positioned after a cleaning flotation unit 23, or after a recover water tank 25, 26, so that purified process water is filtered before it is recirculated back into the flotation line 10.

Further, the process water circuit 20 may comprise a separator overflow tank 22a directly after the gravitational solid-liquid separator (see FIG. 2). The supernatant is led into the separator overflow tank 22a prior to directing it into the cleaning flotation unit, for example to control the volumetric flow into the cleaning flotation unit.

Further, additionally or alternatively, the process water circuit 20 may comprise a mixing unit 22b (see FIG. 2) after the gravitational solid-liquid separator, or after the separator overflow tank 22a, if one is employed. The mixing unit 22b may be of any type known in the field, arranged to enable the addition of desired chemicals such as coagulants and/or flocculants and the treatment of the supernatant by chemical conditioning so that at least the fine particles comprising valuable material may be flocculated prior to leading the supernatant into the cleaning flotation unit. Also other compounds such as soluble SiO₂ may be thus flocculated into solid form particles and thus subsequently removed from the purified process water. This may be required, should supernatant not comprise a sufficient amount of residual collector chemicals as carry-over from the flotation line 10, to ensure sufficient flocculation of fine particles comprising valuable material in the cleaning flotation unit, or ensure the creation of sufficiently large flocs in the cleaning flotation unit. Both the separator overflow tank 22a and the mixing unit 22b may be further utilized to adjust the temperature and/or pH of the supernatant, if desired, to prepare the supernatant for the cleaning flotation.

The process water circuit 20 may further comprise a filtering unit 24 to remove microbes and chemicals promoting microbiological growth, or to remove any other undesired chemicals from the purified process water, or process water 500 being recirculated into the flotation line 10 (see FIG. 2). The filtering unit 24 may be of any type known in the field. In an embodiment, the filtering unit 24 comprises a ceramic filter or a number of ceramic filters.

In the method for treating process water of the flotation arrangement 1, the following steps are effected.

Underflow and/or overflow from a mineral flotation line 10 is treated in a process water circuit 20 comprising a gravitational solid-liquid separator 21 for dewatering underflow and/or overflow of the mineral flotation line 10, to separate sediment 212 from supernatant 211 comprising at least water and fine particles comprising valuable material. The process water circuit 20 further comprises a recover water tank for collecting and/or storing process water 500 comprising overflow and/or underflow from the mineral flotation line 10.

Prior to leading supernatant 211 from the gravitational solid-liquid separator 21 into the recover water tank 25, supernatant 211 is subjected to cleaning flotation in which at least 90% of the flotation gas bubbles have a size from 0.2 to 250 μm, in a cleaning flotation unit 23. In the cleaning flotation, at least unrecovered fine particles comprising valuable material are recovered from supernatant 211. Fine particles comprising valuable material are separated from supernatant 211 into cleaning flotation overflow 231 as recovered valuable material or concentrate, and from there, led into conventional process step for recovering the valuable material (such as a filtering stage). Purified process water 232 is formed as cleaning flotation underflow. Purified process water 232 is recirculated into the mineral flotation line 10, at any suitable or required position of the mineral flotation line 10, for example as dilution water. Alternatively, purified process water may first be collected into the recover water tank 25 as collected process water 500, and then recirculated into the mineral flotation line 10, or into any other process stage of the flotation plant 1.

In an embodiment, the process water circuit 20 comprises a first gravitational solid-liquid separator 21a for dewatering classifier underflow 122 to separate first sediment 212a from supernatant 211a comprising at least water and unrecovered fine particles comprising valuable material. The first gravitational solid-liquid separator 21a may be a slime thickener. First sediment may be collected as concentrate and arranged to flow into a filtering circuit 14 for the recovery of valuable material. Supernatant is collected into the recover water tank 25 as collected process water 500.

Prior to leading supernatant 211a from the first gravitational solid-liquid separator 21a into the recover water tank 25, supernatant 211a is subjected to cleaning flotation, in which at least 90% of the flotation gas bubbles have a size from 0.2 to 250 μm, in a first cleaning flotation unit 23a, 1) for collecting at least unrecovered fine particles comprising valuable material; 2) for separating fine particles comprising valuable material from the supernatant into cleaning flotation overflow 231a as recovered valuable material; and 3) for forming purified process water 232a as cleaning flotation underflow. Purified process water 232a is recirculated into the mineral flotation line 10, or collected into the recover water tank 25 as collected process water 500.

Alternatively or additionally, the process water circuit 20 may comprise a second gravitational solid-liquid separator 21b for dewatering classifier overflow 121 to separate second sediment 212b from supernatant 211b comprising at least water and unrecovered fine particles comprising valuable material. The second gravitational solid-liquid separator 21b may be a flotation thickener. Second sediment 212b is led into the mineral flotation circuit 13 as slurry infeed. Supernatant 211b is collected into the recover water tank 25 as collected process water 500.

Alternatively or additionally, the process water circuit 20 may comprise a third gravitational solid-liquid separator 21c for dewatering cleaner overflow 131b from the flotation circuit 13 to separate third sediment 212c from supernatant 211c comprising at least water and unrecovered fine particles comprising valuable material. The third gravitational solid-liquid separator 21c may be a valuable material concentrate thickener, for example a high-rate thickener. The supernatant 211c may further comprise residual flotation chemicals, colloidal and soluble compounds, and microbes. Supernatant 211c is collected into the recover water tank 25 as collected process water 500. Third sediment 212c may be collected as concentrate and led into further treatment to recover the target valuable material, for example in a filtering stage (not shown in figures).

Alternatively or additionally, the process water circuit 20 may comprise a fourth gravitational solid-liquid separator 21d for dewatering rougher underflow 132a from the flotation circuit 13 to separate fourth sediment 212d from supernatant 211d comprising at least water and unrecovered fine particles comprising valuable material. The fourth gravitational solid-liquid separator 21d may be a tailings thickener. Supernatant 211d may further comprise residual flotation chemicals, colloidal and soluble compounds, and microbes. Supernatant 211d is collected into the recover water tank 25 as collected process water 500. Fourth sediment 212d may be removed from the flotation plant 1 as tailings, and treated accordingly, for example in a tailings dam.

In an embodiment, prior to recirculating one or more supernatant 211a, 211b, 211c, 211d as collected process water 500 from the recover water tank 25 into the mineral flotation line 10, collected process water 500 is subjected to cleaning flotation, in which at least 90% of the flotation gas bubbles have a size from 0.2 to 250 μm, in a second cleaning flotation unit 23b, 1) for collecting at least unrecovered fine particles comprising valuable material, 2) for separating fine particles comprising valuable material from the collected process water into cleaning flotation overflow 231b as recovered valuable material, and 3) for forming purified process water 232b as cleaning flotation underflow; that purified process water may then be recirculated into the mineral flotation line 10.

The cleaning flotation may be dissolved gas flotation (DAF), i.e. the cleaning flotation unit 23 may be a DAF unit.

Depending on the configuration of the flotation plant 1, the process water circuit 20 may thus comprise 1 to 4 gravitational solid-liquid separators 21. In order to recover fine particles comprising valuable material from overflow and/or underflow of the flotation line 10, supernatant 211a, 211b, 211c, 211d from a gravitational solid-liquid separator or from a number of gravitational solid-liquid separators 21a, 21b, 21c, 21d may first be collected into the recover water tank 25, and the led into the second cleaning flotation unit 23b (FIG. 3).

Alternatively or additionally, supernatant 211a from the first gravitational solid-liquid separator 21a may be first led into the first cleaning flotation unit 23a, and then led into the recover water tank 25, or recirculated back into the flotation line 10 at some suitable point of the flotation line 10, for example as dilution water, i.e. the configuration may be a combination of the alternatives shown in FIGS. 2 and 3.

Prior to recirculating purified process water into the mineral flotation line 10, it may be collected into and/or stored in a second recover water tank 26.

Further, prior to recirculating purified process water into the mineral flotation line 10, or prior to recirculating process water 500 from a recover water tank 25, 26 into the mineral flotation line 10, water may be subjected to filtration step in a filtering unit 24, to remove microbes and chemicals promoting microbiological growth, or to remove any other undesired chemicals from the purified process water, or process water 500 being recirculated into the mineral flotation line 10 (see FIG. 2).

Prior to leading overflow and/or underflow 121, 122, 131b, 132a from the mineral flotation line 10 to a gravitational solid-liquid separator 21, 21a, 21b, 21c, 21d, the concentration of overflow and/or underflow 121, 122, 131b, 132a may be adjusted to 0.5 to 15 w-%, in any conventional manner, for example by using recirculated process water 500 as dilution water. Further, by this, turbulent flow of overflow and/or underflow from the mineral flotation line 10 may be adjusted to a laminar flow as it is led into the gravitational solid-liquid separator 21, 21a, 21b, 21c, 21d.

For example, in the fourth gravitational solid-liquid separator 21d, (“tailings thickener”), the incoming underflow 132a may have a concentration typically of 35 to 45 w-%. By lowering the concentration to 0.5 to 15 w-% by addition of process water 500, improved settling of solid particles in laminar conditions may be achieved, as ideal conditions for a washing step of fine particles is created. Generally, fine particles below 10 μm in particle size will then follow water into the supernatant rather than settling to the bottom of the gravitational solid-liquid separator as sediment. A person skilled in the art can adjust the suitable concentration with information of the size range and density of the material of the incoming underflow and/or overflow in regard to the rate of ascending or surface load of the gravitational solid-liquid separator.

The residence time of overflow and/or underflow 121, 122, 131b, 132a in a gravitational solid-liquid separator 21, 21a, 21b, 21c, 21d is under 10 hours. The residence time may be 0.5 to 8 hours, for example 1 hour; 2.25 hours; 3.5 hours; 4 hours; 5.75 hours; or 6.5 hours.

Temperature of supernatant 211, 211a, 211b, 211c, 211d may be adjusted to 2-60° C., and the pH adjusted to 6-12 prior to leading it into a cleaning flotation unit 23, 23a, 23b. The pH may be, or may be adjusted to, for example 7; or 7.3; or 7.5; or 8; or 9.25. The temperature and the pH of the supernatant 211, 211a, 211b, 211c, 211d may be adjusted to optimize the cleaning flotation in the cleaning flotation unit 23, 23a, 23b, or the preceding process steps may cause the temperature and/or the pH of the supernatant to display certain values. The aforementioned properties of supernatant 211211a, 211b, 211c, 211d may be separately adjusted in the separator overflow tank 22a.

Depending on the type of raw material or ore treated in the flotation plant 1, a significant amount of fine particles comprising valuable material, unrecovered in the mineral flotation line 10, may be recovered from supernatant 211, 211a, 211b, 211c, 211d of a gravitational solid-liquid separator (21, 21a, 21b, 21c, 21d). In an embodiment, at least 40% of fine particles comprising valuable material are recovered. In some cases, up to 90% of fine particles comprising valuable material may be recovered.

After the cleaning flotation, cleaning flotation overflow 231, 231a, 231b is removed as concentrate, and purified process water 232, 232a, 232b is recirculated into the mineral flotation circuit 10. Prior to recirculating the purified process water 231 into the mineral flotation circuit 10, it may be subjected to a filtration step for removing chemicals promoting microbiological growth, or for removing other undesired or detrimental chemical compounds. In the filtration step, a filtering unit 24 comprising a ceramic filter may be used.

Hardness of purified process water 232, 232a, 232b may be unaffected by the process water circuit 20 and/or the method for treating process water, i.e. hardness of water of underflow and/or overflow 121, 122, 131b, 132a from the mineral flotation line 10 is the substantially the same as hardness of water of the purified process water 232, 232a, 232b, or process water 500, recirculated into the mineral flotation line 10.

In an additional method step, prior to leading supernatant 211, 211a, 211b, 211c, 211d from a gravitational solid-liquid separator 21, 21a, 21b, 21c, 21d into cleaning flotation, supernatant may be led into a separator overflow tank 22a. Additionally or alternatively, prior to leading supernatant 211, 211a, 211b, 211c, 211d from a gravitational solid-liquid separator 21, 21a, 21b, 21c, 21d into cleaning flotation, the supernatant may be led into mixing unit 22b for chemically conditioning the supernatant by adding a coagulant and/or a flocculant to flocculate at least fine particles comprising valuable material in supernatant. The coagulant may be chosen from a group comprising: inorganic coagulants, aluminium salts, iron salts, organic coagulants.

One possible inorganic coagulant is polyaluminium chloride (PAC). An inorganic coagulant may be added into the supernatant 211, 211a, 211b, 211c, 211d in the mixing unit 22b in an amount of 1 to 2000 ppm, for example in an amount of 5 ppm, 10 ppm, 25 ppm, 50 ppm, 75 ppm, 150 ppm, 225 ppm, 350 ppm, or 400 ppm. In an embodiment, 100 ppm PAC is added. An organic coagulant may be added into the supernatant 211, 211a, 211b, 211c, 211d in an amount of 5 to 200 ppm.

Alternatively or additionally, the supernatant 211, 211a, 211b, 211c, 211d may be conditioned in the mixing unit 22b by adding a flocculant to further assist in recovering fine particles comprising valuable material from supernatant 211, 211a, 211b, 211c, 211d by flocculating them. For example, natural flocculant such as starch or modified starch, or polysaccharides may be used. For example, synthetic flocculants may be used. The synthetic flocculants may display different charges. Examples of synthetic flocculants are: high molecular weight (over 500 000) flocculants such as polyacrylamides (negatively or positively charged, or neutral), or Mannich products (positively charged); and low molecular weight (under 500 000) flocculants such as polyamines (positively charged), polyepiamine (positively charged), polyDADMAC (positively charged), poly(ethylene)imines (positively charged), or polyethylene oxide (neutral).

A flocculant may be added in an amount of 1 to 100 ppm, for example in an amount of 1.25 ppm, 1.75 ppm, 2.25 ppm, 7.5 pp, or 12.25 ppm. In an embodiment, 2 ppm of a flocculant is added.

Use of the arrangement according to the above description may be employed in a flotation plant 1 intended for recovering valuable material from ore having a density below 4 g/cm³, preferably 2.4 to 3.2 g/cm³. For example, spodumene has a density of 3.11 g/cm³. In an embodiment, the valuable material is Li. In an embodiment, the valuable material is Pt. In an embodiment, the raw material of the flotation plant 1 is spodumene ore, from which lithium is intended to be recovered. In an embodiment, PGM minerals or other sources of Pt are utilized as raw material for the flotation plant 1, indented for recovering Pt.

1. A method of treating process water of a flotation plant for the recovery of a valuable material, the flotation plant comprising a mineral flotation line, the mineral flotation line comprising
a grinding mill;
a classification circuit for classifying a feed of ground ore from the grinding mill into classifier overflow and classifier underflow; and
a mineral flotation circuit for treating classifier overflow as infeed of ore particles comprising valuable material suspended in slurry, the flotation circuit comprising a rougher part for the separation of slurry infeed into rougher overflow of recovered valuable material and rougher underflow of reject, and a cleaner part arranged to receive rougher overflow from the rougher part as slurry infeed, for the separation of slurry into cleaner overflow of recovered valuable material and cleaner underflow arranged to flow back into the rougher part as slurry infeed,
the flotation plant further comprising a process water circuit for treating underflow and/or overflow of the mineral flotation line, the process water circuit comprising a gravitational solid-liquid separator for dewatering underflow and/or overflow of the mineral flotation line to separate sediment from supernatant comprising at least water and unrecovered fine particles comprising valuable material; and a recover water tank for collecting process water comprising overflow and/or underflow from the mineral flotation line,
wherein, prior to leading supernatant from the gravitational solid-liquid separator into the recover water tank, supernatant is subjected to cleaning flotation, in which at least 90% of the flotation gas bubbles have a size from 0.2 to 250 μm, in a cleaning flotation unit for collecting at least unrecovered fine particles comprising valuable material; for separating fine particles comprising valuable material from the supernatant into cleaning flotation overflow as recovered valuable material; and for forming purified process water as cleaning flotation underflow; and in that purified process water is recirculated into the mineral flotation line, or collected into the recover water tank as collected process water.

2. The method according to claim 1, wherein the process water circuit comprises a first gravitational solid-liquid separator for dewatering classifier underflow to separate first sediment from supernatant comprising at least water and unrecovered fine particles comprising valuable material; first sediment arranged to flow into the filtering circuit for the recovery of valuable material and supernatant collected into the recover water tank as collected process water.

3. The method according to claim 2, wherein prior to leading supernatant from the first gravitational solid-liquid separator into the recover water tank, supernatant is subjected to cleaning flotation, in which at least 90% of the flotation gas bubbles have a size from 0.2 to 250 μm, in a first cleaning flotation unit for collecting at least unrecovered fine particles comprising valuable material; for separating fine particles comprising valuable material from supernatant into cleaning flotation overflow as recovered valuable material; and for forming purified process water as cleaning flotation underflow; and in that purified process water is recirculated into the mineral flotation line, or collected into the recover water tank as collected process water.

4. The method according to claim 1, wherein the process water circuit comprises a second gravitational solid-liquid separator for dewatering classifier overflow to separate second sediment from supernatant comprising at least water and unrecovered fine particles comprising valuable material; second sediment led into the mineral flotation circuit as slurry infeed; and supernatant collected into the recover water tank as collected process water.

5. The method according to claim 1, wherein the process water circuit comprises a third gravitational solid-liquid separator for dewatering cleaner overflow from the flotation circuit to separate third sediment from supernatant comprising at least water and unrecovered fine particles comprising valuable material; supernatant collected into the recover water tank as collected process water.

6. The method according to claim 1, wherein the process water circuit comprises a fourth gravitational solid-liquid separator for dewatering rougher underflow from the flotation circuit to separate fourth sediment from supernatant comprising at least water and unrecovered fine particles comprising valuable material; supernatant collected into the recover water tank as collected process water.

7. The method according to claim 1, wherein prior to recirculating collected process water from the recover water tank into the mineral flotation line, collected process water is subjected to cleaning flotation, in which at least 90% of the flotation gas bubbles have a size from 0.2 to 250 μm, in a second cleaning flotation unit for collecting at least unrecovered fine particles comprising valuable material, for separating fine particles comprising valuable material from collected process water into cleaning flotation overflow as recovered valuable material, and for forming purified process water as cleaning flotation underflow; and in that purified process water is recirculated into the mineral flotation line.

8. The method according to claim 1, wherein prior to leading overflow and/or underflow from the mineral flotation line to a gravitational solid-liquid separator, the concentration of overflow and/or underflow is adjusted to 0.5 to 15 w-%.

9. The method according to claim 8, wherein turbulent flow of overflow and/or underflow from the mineral flotation line is adjusted to a laminar flow as it is led into the gravitational solid-liquid separator.

10. The method according to claim 1, wherein at least 40% of fine particles comprising valuable material, unrecovered in the mineral flotation line, are recovered from supernatant of a gravitational solid-liquid separator.

11. The method according to claim 1, wherein the residence time of overflow and/or underflow from the mineral flotation line in the gravitational solid-liquid separator is under 10 hours, preferably 0.5 to 8 hours.

12. The method according to claim 1, wherein prior to leading supernatant from a gravitational solid-liquid separator into cleaning flotation, supernatant is led into a separator overflow tank.

13. The method according to claim 1, wherein prior to leading supernatant from a gravitational solid-liquid separator into cleaning flotation, the supernatant is led into mixing unit for chemically conditioning supernatant by adding a coagulant and/or a flocculant to flocculate at least fine particles comprising valuable material in supernatant.

14. The method according to claim 13, characterized in that the coagulant is chosen from a group comprising: inorganic collector, aluminium salts, iron salts, organic coagulants.

15. The method according to claim 13, wherein a coagulant is added into supernatant in an amount of 1 to 2000 ppm.

16. The method according to claim 13, wherein the flocculant is chosen from a group comprising: natural polymers, synthetic flocculants.

17. The method according to claim 13, wherein a flocculant is added into supernatant in an amount of 1 to 100 ppm.

18. The method according to claim 1, wherein the temperature of supernatant is adjusted to 2-60° C. prior to leading it into a cleaning flotation unit.

19. The method according to claim 1, wherein the pH of supernatant is adjusted to 6-12 prior to leading in into a cleaning flotation unit.

20. The method according to claim 1, wherein the cleaning flotation unit is a dissolved gas flotation (DAF) unit.

21. The method according to claim 1, wherein the valuable material is Li.

22. The method according to claim 1, wherein the valuable material is Pt.

23. An arrangement for of treating process water of a flotation plant for the recovery of a valuable material, the flotation plant comprising a mineral flotation line, the mineral flotation line comprising
a grinding mill;
a classification circuit for classifying a feed of ground ore from the grinding mill into classifier overflow and classifier underflow; and
a mineral flotation circuit for treating ore particles comprising valuable material and suspended in slurry, the mineral flotation circuit comprising a rougher part for the separation of slurry infeed into rougher overflow of recovered valuable material and rougher underflow of reject, and a cleaner part arranged to receive rougher overflow from the rougher part as slurry infeed, for the separation of slurry into cleaner overflow of recovered valuable material and cleaner underflow arranged to flow back into the rougher part as slurry infeed,
the flotation plant further comprising a process water circuit for treating underflow and/or overflow of the mineral flotation line, the process water treatment circuit comprising a gravitational solid-liquid separator arranged to dewater underflow and/or overflow of the mineral flotation line to separate sediment from supernatant comprising at least water and unrecovered fine particles comprising valuable material; and a recover water tank for collecting process water comprising overflow and/or underflow from the mineral flotation line,
wherein the water treatment circuit further comprises a cleaning flotation unit employing flotation gas bubbles of which at least 90% have a size from 0.2 to 250 μm, operationally connected to the gravitational solid-liquid separator for receiving supernatant prior to it being led into the recover water tank, and arranged to collect at least unrecovered fine particles comprising valuable material; to separate fine particles comprising valuable material from supernatant into cleaning flotation overflow as recovered valuable material; and to form purified process water as cleaning flotation underflow configured to be recirculated into the mineral flotation line, or collected into the recover water tank as collected process water.

24. The arrangement according to claim 23, wherein the process water circuit comprises a first gravitational solid-liquid separator arranged to dewater classifier underflow to separate first sediment from supernatant comprising at least water and unrecovered fine particles comprising valuable material; first sediment arranged to flow into the filtering circuit for the recovery of valuable material; supernatant configured to be collected into the recover water tank as collected process water.

25. The arrangement according to claim 24, wherein the water treatment circuit comprises a first cleaning flotation unit employing flotation gas bubbles of which at least 90% have a size from 0.2 to 250 μm, operationally connected to the first gravitational solid-liquid separator for receiving supernatant, and arranged to collect at least unrecovered fine particles comprising valuable material; to separate fine particles comprising valuable material from supernatant into cleaning flotation overflow as recovered valuable material; and to form purified process water as cleaning flotation underflow configured to be recirculated into the mineral flotation line, or collected into the recover water tank as collected process water.

26. The arrangement according to claim 23, wherein the process water circuit comprises a second gravitational solid-liquid separator arranged to dewater classifier overflow to separate second sediment from supernatant comprising at least water and unrecovered fine particles comprising valuable material; second sediment arranged to flow into the mineral flotation circuit as slurry infeed; and supernatant configured to be collected into the recover water tank as collected process water.

27. The arrangement according to claim 23, wherein the process water circuit comprises a third gravitational solid-liquid separator arranged to dewater cleaner overflow from the mineral flotation circuit to separate third sediment from supernatant comprising at least water and unrecovered fine particles comprising valuable material; supernatant configured to be collected into the recover water tank as collected process water.

28. The arrangement according to claim 23, wherein the process water circuit comprises a fourth gravitational solid-liquid separator arranged to dewater rougher underflow from the mineral flotation circuit to separate fourth sediment from supernatant comprising at least water and unrecovered fine particles comprising valuable material;
supernatant configured to be collected into the recover water tank as collected process water.

29. The arrangement according to claim 23, wherein the process water circuit further comprises a second cleaning flotation unit employing flotation gas bubbles of which at least 90% have a size from 0.2 to 250 μm, operationally connected to the recover water tank for receiving collected process water, and arranged to collect at least unrecovered fine particles comprising valuable material, to separate fine particles comprising valuable material from collected process water into cleaning flotation overflow as recovered valuable material, and to form purified process water as cleaning flotation underflow; purified process water is configured to be recirculated into the mineral flotation line.

30. The arrangement according to claim 23, wherein the process water circuit comprises a separator overflow tank into which supernatant from a gravitational solid-liquid separator is configured to flow prior to being led into cleaning flotation.

31. The arrangement according to claim 23, wherein the process water circuit further comprises a mixing unit into which supernatant from a gravitational solid-liquid separator is configured to flow prior to being led into cleaning flotation, the mixing unit arranged to chemically condition supernatant to flocculate at least fine particles comprising valuable material in supernatant.

32. The arrangement according to claim 23, wherein the cleaning flotation unit is a dissolved gas flotation (DAF) unit.

33. Use of the arrangement according to claim 23 for recovering valuable material from ore having a density under 4 g/cm³, preferably 2.4 to 3.2 g/cm³.

34. The use according to claim 33 for recovering Li.

35. The use according to claim 34 for recovering Li from spodumene.

36. The use according to claim 33 for recovering Pt.

37. The use according to claim 36 for recovering Pt from a PGM mineral.
